(19) United States
(12) Patent Application Publication
(10) Pub. No.: US 2025/0335258 A1
(43) Pub. Date: Oct. 30, 2025

(54) METHOD, DEVICE, AND COMPUTER PROGRAM FOR PERFORMING COMPUTATION USING PROCESSING-IN-MEMORY (PIM)

(71) Applicant: SAMSUNG SDS CO., LTD., Seoul (KR)

(72) Inventors: Jimyoung SON, Seoul (KR); Hyojung LEE, Seoul (KR); Jieun CHOI, Seoul (KR); Daehyeon BAEK, Seoul (KR)

(73) Assignee: SAMSUNG SDS CO., LTD., Seoul (KR)

(21) Appl. No.: 19/189,724

(22) Filed: Apr. 25, 2025

(30) Foreign Application Priority Data
Apr. 25, 2024 (KR) 10-2024-0055161
Sep. 26, 2024 (KR) 10-2024-0130936

(51) Int. Cl. G06F 9/50

(52) U.S. Cl. CPC G06F 9/5038; G06F 9/5016

(57) ABSTRACT

The present disclosure relates to a method, a device, and a computer program for performing computation using PIM. The present disclosure presents a method for performing computation using PIM, the method including: parsing a user request into multiple tasks; grouping the multiple parsed tasks into at least one batched task unit; scheduling execution of the batched task unit, based on data movement between the multiple tasks; and executing the multiple tasks according to the scheduling.

### CROSS-REFERENCE TO RELATED APPLICATION(S)

This application is based on and claims priority under 35 U.S.C. 119 to Korean Patent Application No. 10-2024-0055161, filed on Apr. 25, 2024 and Korean Patent Application No. 10-2024-0130936, filed on Sep. 26, 2024, in the Korean Intellectual Property Office, the disclosure of which is herein incorporated by reference in its entirety.

### BACKGROUND OF THE INVENTION

### 1. Field of the Invention

The present disclosure relates to a method, a device, and a computer program for performing computation using PIM and, more specifically, to a method, a device, and a computer program for performing computation using a CPU or GPU and PIM together. More specifically, the present disclosure relates to a method, a device, and a computer program for enabling PIM, which efficiently processes memory-intensive computation, to perform computation in parallel with a CPU or GPU, which are traditional computing devices.

### 2. Description of the Prior Art

Processing-in-memory (PIM) architecture was proposed as early as the 1960s, but due to the limitations and restrictions of memory technology at the time, it was very difficult to actually implement PIM-related logic inside or near a memory. It can be said that implementation of the PIM architecture has only recently been realized since the PIM architecture began to be physically implemented in the form of FPGAs or ASICs in 2020 or later. Due to this slow implementation and research, studies on processing applications or workloads using PIM are also still at an early stage. While some research on the processing of simple linear algebra operations using PIM already exists, there is still very limited research on computing systems or memory architectures for efficiently processing applications or workloads in an environment where PIM is mixed with existing computing devices such as GPUs and CPUs.

In other words, although there is a need for a computational method for efficiently processing applications or workloads in an environment where PIM and GPU/CPU are mixed, no suitable solution has yet been presented.

### SUMMARY OF THE INVENTION

The present disclosure was designed to solve the problems of the prior art described above, and an aspect of the present disclosure is to provide a method, a device, and a computer program for performing computation using PIM.

Furthermore, an aspect of the present disclosure is to provide a method, a device, and a computer program for performing computation using a CPU or GPU and PIM together.

Furthermore, an aspect of the present disclosure is to provide a method, a device, and a computer program for enabling PIM to perform computation in parallel with a CPU or GPU.

Furthermore, an aspect of the present disclosure is to provide a method, a device, and a computer program that can alleviate a memory bound problem in a computing system by enabling PIM to perform computation in parallel with a CPU or GPU.

Furthermore, an aspect of the present disclosure is to provide a method, a device, and a computer program that can improve the performance of processing applications or workloads by enabling PIM to perform computation in parallel with a CPU or GPU.

Furthermore, an aspect of the present disclosure is to provide a method, a device, and a computer program that presents a heterogeneous computing framework for servicing applications or workloads by enabling PIM to perform computation in parallel with a CPU or GPU.

Furthermore, an aspect of the present disclosure is to provide a method, a device, and a computer program that enable parallel processing of a user request through synchronization and asynchronization of the computation order by enabling PIM to perform computation in parallel with a CPU or GPU.

Furthermore, an aspect of the present disclosure is to provide a method, a device, and a computer program that enables the efficient co-use of PIM and GPU/CPU utilizing data movement and replication between memories by enabling PIM to perform computation in parallel with the CPU or GPU.

Furthermore, an aspect of the present disclosure is to provide a method, a device, and a computer program that enables the acceleration of LLM inference computation by enabling PIM to perform computation in parallel with the CPU or GPU.

The technical problems to be solved in the present disclosure are not limited to the technical problems mentioned above, and other technical problems not mentioned will be clearly understood by those skilled in the art to which the present disclosure belongs from the description of the present specification.

According to a first aspect of the present disclosure, a method for performing computation using PIM may include: parsing a user request into multiple tasks; grouping the multiple parsed tasks into at least one batched task unit, scheduling execution of the batched task unit, based on data movement between the multiple tasks; and executing the multiple tasks according to the scheduling.

The tasks may be classified based on computation and a VUR.

The VUR may be defined as a pair of a computing resource and a memory resource.

The computing resource may include at least one of a CPU, a GPU, and PIM.

The memory resource may be allocable to the computing resource.

The tasks may be registered in case that the memory resource of the VUR is allocable.

Multiple tasks grouped into the same batched task may be performed simultaneously in parallel with each other.

A second aspect of the present disclosure may relate to a computer program stored on a medium to execute a method for performing computation using PIM, in combination with hardware.

According to a third aspect of the present disclosure, a device for performing computation using PIM may include a processor, wherein the processor is configured to: parse a user request into multiple tasks; group the multiple parsed tasks into at least one batched task unit; schedule execution of the batched task unit, based on data movement between the multiple tasks; and execute the multiple tasks according to the scheduling.

The tasks may be classified based on computation and a VUR.

The VUR may be defined as a pair of a computing resource and a memory resource.

The computing resource may include at least one of a CPU, a GPU, and PIM.

The memory resource may be allocable to the computing resource.

The tasks may be registered in case that the memory resource of the VUR is allocable.

Multiple tasks grouped into the same batch task may be performed simultaneously in parallel with each other.

Accordingly, the method, the device, and the computer program for performing computation using a CPU or GPU and PIM together, according to an embodiment of the present disclosure enable the PIM to perform computation in parallel with the CPU or GPU.

Furthermore, the method, the device, and the computer program for performing computation using a CPU or GPU and PIM together, according to an embodiment of the present disclosure, enables the PIM to perform computation in parallel with the CPU or GPU, thereby alleviating a memory-bound problem in a computing system.

Furthermore, the method, the device, and the computer program for performing computation using a CPU or GPU and PIM together, according to an embodiment of the present disclosure, enables the PIM to perform computation in parallel with the CPU or GPU, thereby improving the performance of processing applications or workloads.

Furthermore, the method, the device, and the computer program for performing computation using a CPU or GPU and PIM together, according to an embodiment of the present disclosure, enables the PIM to perform computation in parallel with the CPU or GPU, thereby presenting a heterogeneous computing framework for servicing applications or workloads.

Furthermore, the method, the device, and the computer program for performing computation using a CPU or GPU and PIM together, according to an embodiment of the present disclosure, enables the PIM to perform computation in parallel with the CPU or GPU, thereby enabling parallel processing of a user request through the synchronization and asynchronization of computation order.

Furthermore, the method, the device, and the computer program for performing computation using a CPU or GPU and PIM together, according to an embodiment of the present disclosure, enables the PIM to perform computation in parallel with the CPU or GPU, thereby enabling efficient co-use of the PIM and the GPU/CPU that utilize data movement and replication between memories.

Furthermore, the method, the device, and the computer program for performing computation using a CPU or GPU and PIM together, according to an embodiment of the present disclosure, enables the PIM to perform computation in parallel with the CPU or GPU, thereby enabling acceleration of LLM inference computation.

The effects that can be obtained from the present disclosure are not limited to the effects mentioned above, and other effects not mentioned will be clearly understood by those skilled in the art to which the present disclosure belongs from the description of the present specification.

### BRIEF DESCRIPTION OF THE DRAWINGS

The accompanying drawings, which are included as part of the detailed description to help understand the present disclosure, provide an embodiment of the present disclosure and illustrate the technical idea of the present disclosure along with the detailed description.

FIG. 1 illustrates a heterogeneous computing framework that can perform computation using processing-in-memory (PIM) according to an embodiment of the present disclosure;

FIG. 2 illustrates the operation of a request parser and a task queue according to an embodiment of the present disclosure;

FIG. 3 illustrates the timeline and data movement of a batched task according to an embodiment of the present disclosure;

FIG. 4 illustrates mapping of batched tasks and VURs according to an embodiment of the present disclosure;

FIG. 5 illustrates the role of a memory buffer manager according to an embodiment of the present disclosure;

FIG. 6 illustrates a sequence diagram showing a task registration process according to an embodiment of the present disclosure;

FIG. 7 illustrates a sequence diagram showing a task execution process according to an embodiment of the present disclosure;

FIG. 8 illustrates a sequence diagram showing a task deletion process according to an embodiment of the present disclosure;

FIG. 9 illustrates a PIM general matrix-vector multiplication (PIM GEMV) computation process according to prior art;

FIG. 10 illustrates a PIM-friendly attention-score computation acceleration method according to an embodiment of the present disclosure;

FIG. 11 illustrates a PIM-friendly attention-value computation acceleration method according to an embodiment of the present disclosure; and

FIG. 12 illustrates a device 1200 to which a proposed method of the present disclosure may be applied.

### DETAILED DESCRIPTION

Hereinafter, the embodiments disclosed in the present specification will be described in detail with reference to the accompanying drawings. The aspects, specific advantages, and novel features of the present disclosure will become apparent from the following detailed description and preferred embodiments associated with the accompanying drawings.

The terms and words used in the present specification and in the claims are defined appropriately by the inventor to best describe the disclosure and should be construed as meanings or concepts consistent with the technical idea of the present disclosure. The terms and words are merely provided to describe embodiments and should not be construed as limiting the present disclosure.

In assigning reference numerals to components, identical or similar components are assigned the same reference numerals regardless of the reference numerals, and redundant descriptions thereof will be omitted. The suffixes “module” and “unit” for components, used in the following description, are given or used interchangeably for ease of drafting the specification, do not inherently have distinct meanings or roles, and may refer to either software or hardware components.

In describing the components of the present disclosure, when a component is expressed in the singular form, it is to be understood that the component also includes the plural form unless otherwise specifically stated. Furthermore, the terms “first,” “second,” and the like are used to distinguish one component from another, and the components are not limited by the terms. Furthermore, when a component is connected to another component, itis intended that another component may be connected between the component and the other component.

Furthermore, in describing embodiments disclosed in the present specification, detailed descriptions of related well-known technologies may be omitted when the detailed descriptions are considered to obscure the essence of the embodiments disclosed in the present specification. Furthermore, the accompanying drawings are provided only to facilitate understanding of the embodiments disclosed in the present specification, and it is to be understood that the technical idea disclosed in the present specification is not limited by the accompanying drawings and include all modifications, equivalents, or substitutions that are within the scope of the idea and technology of the present disclosure.

Hereinafter, exemplary embodiments of a method, a device, and a computer program for performing computation by using PIM according to the present disclosure will be described in detail with reference to the accompanying drawings.

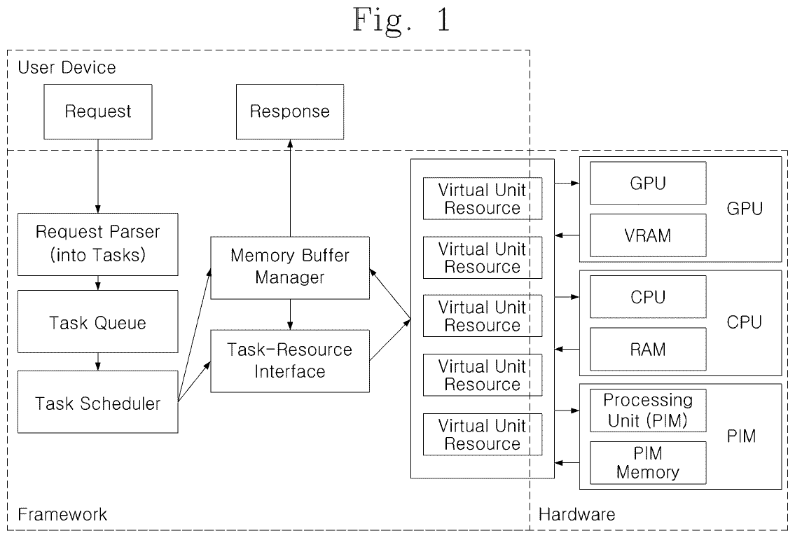

FIG. 1 illustrates a heterogeneous computing framework that can perform computation with a GPU/CPU by using processing-in-memory (PIM) according to an embodiment of the present disclosure.

The heterogeneous computing framework according to an embodiment of the present disclosure has features: (1) parallel processing of user requests through synchronization and asynchronization of computation order; (2) efficient co-use of PIM and GPU/CPU utilizing data movement and replication between memories; and (3) acceleration of LLM inference computation using PIM.

Referring to FIG. 1, the three features of a heterogeneous computing framework according to an embodiment of the present disclosure will be described in detail.

In relation to the parallel processing of a user request through synchronization and asynchronization of the computation order (feature (1) described above), a user request is parsed into and defined as a series of computational units called “tasks,” and a computing resource pair, i.e., a computing resource and memory resource pair, that enables efficient execution of computation for each task is defined as a “virtual unit resource (VUR).” As shown in FIG. 1, a user request is divided into multiple tasks, and each task is assigned to multiple VURs, and computation is performed. The result of the computation performed as described above is returned to a user terminal as a response. More specifically, when a request is submitted from a user terminal, a request parser divides the request into task units and stores the tasks in a task queue. The tasks stored in the task queue are scheduled by a task scheduler to enable parallel processing through synchronization and asynchronization of the computation order. A task-resource interface maps the tasks and VURs, based on scheduling information received from the task scheduler.

Furthermore, in relation to the efficient co-use of PIM and GPU/CPU utilizing data movement and replication between memories (feature (2)), when the computation result of a previous batched task (a task grouping unit defined to group multiple tasks for parallel computation on multiple VURs) is used in the computation of a next batched task, a memory buffer manager transmits commands for data movement and replication between PIM and GPU/CPU memories to the VURs via the task-resource interface. Furthermore, the PIM incurs an overhead of changing the layout of data required for the computation to fit the memory, and to reduce this overhead, the memory buffer manager transmits data layout change information to the task-resource interface before the computation. In the embodiment in FIG. 1, the memory of the GPU is represented as VRAM, the memory of the CPU is represented as RAM, and the memory of the PIM is represented as a PIM memory. However, the memory is not limited to those types of memories, and any type of memory can be used as long as the memory can be allocated to each computational resource (GPU, CPU, or PIM).

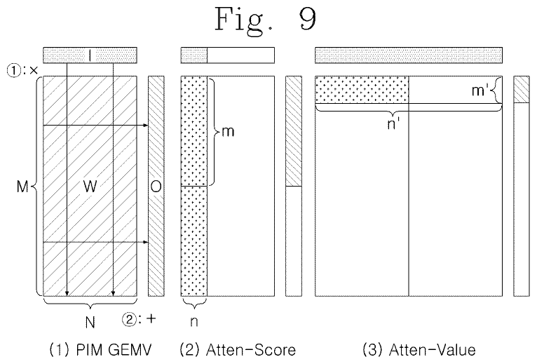

Furthermore, in relation to acceleration of LLM inference computation utilizing PIM (feature (3)), the memory buffer manager accelerates LLM inference computation by transforming the format of an operand data matrix to align with the read/write/computation protocols of PIM. Feature (3) will be described in detail later with reference to FIGS. 9 to 11.

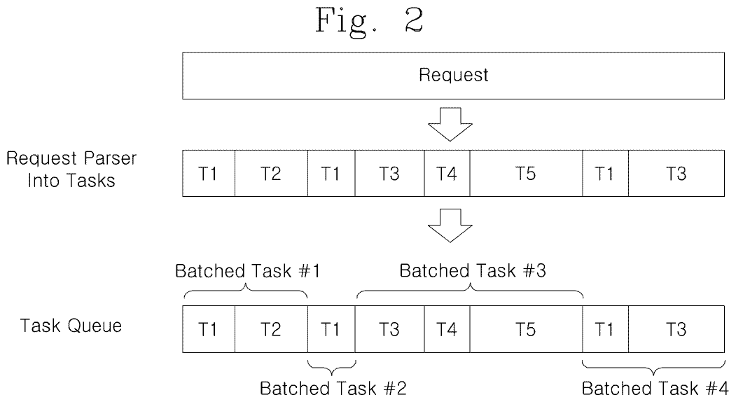

FIG. 2 illustrates the operations of a request parser and a task queue according to an embodiment of the present disclosure.

As shown in FIG. 2, when a request is received from a user terminal, the request parser parses the request into task units. Here, the tasks vary (are distinguished) by the type of computation and a VUR (or a VUR type). A VUR is defined as a pair of computing resource and memory resource, and a task is defined as the type of computation and a VUR used (a pair of computing resource and memory resource) (this may be expressed as follows).

$$Virtual Unit Resource ( V U R ) = ( Computing Resource , Memory Resource )$$

$$Task = ( Computation , V U R ( Computing Resource , Memory Resource ) )$$

Therefore, for example, the same type of computation (e.g., addition) is categorized into different tasks when the computation is performed on a GPU or when the computation is performed on PIM (computing resources are different).

The task queue defines (produces) a batched task in order to group the parsed tasks to simultaneously perform computation in parallel on multiple VURs. In FIG. 2, T1 (Task 1) and T2 (Task 2) on the left may be simultaneously performed in parallel on different VURs, so T1 and T2 are grouped together and defined as Batched Task #1. Each batched task is defined by tasks constituting each batched task and whether data is moved to the next batched task. For example, if T2 in Batched Task #1 is performed on the PIM and T1 in Batched Task #2 is performed on the GPU, data movement from the PIM to the GPU is required after Batched Task #1 is completed.

$$i - th Batched Task = ( Tasks , Data Movement for ( i + 1 ) th Batched Task )$$

Referring back to FIG. 2, it can be found that: in Batched Task #2, only Task 1 is performed; in Batched Task #3, Tasks 3, 4, and 5 are performed simultaneously; and in Batched Task #4, Tasks 1 and 3 are performed simultaneously.

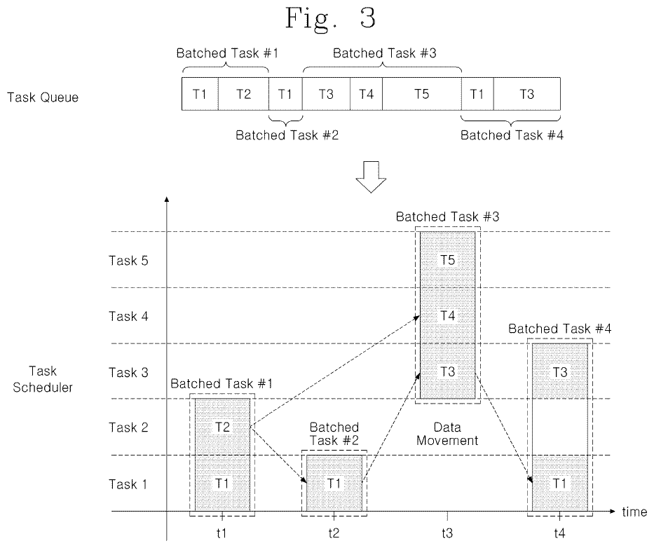

FIG. 3 illustrates a timeline and data movement of a batched task according to an embodiment of the present disclosure.

Tasks (or batched tasks) stored in the task queue are scheduled by the task scheduler to enable parallel processing through synchronization and asynchronization of the computation order. FIG. 3 illustrates a method by which batched tasks are scheduled for each timeline. Tasks within the same batched task contained in the task queue are not interdependent, and thus may be simultaneously executed in parallel. After each batch task is completed, the task scheduler marks the case in which data movement required, and transmits the information to the memory buffer manager in the next step. Whether data is moved depends on a VUR to which each task is mapped. The task scheduler has two roles: i) task-resource mapping and ii) data movement check.

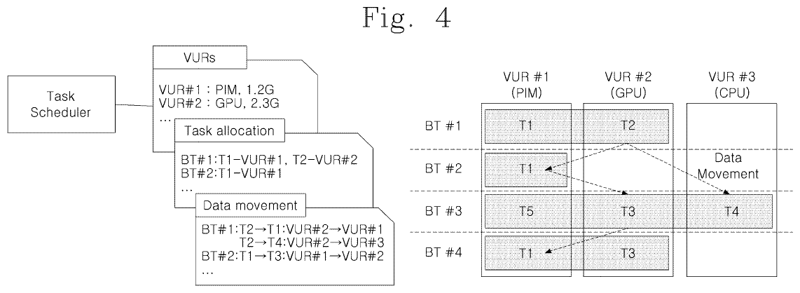

FIG. 4 illustrates mapping of batch tasks and VURs according to an embodiment of the present disclosure.

In FIG. 4, VUR #1 has PIM as a computing resource, VUR #2 has a GPU as a computing resource, and VUR #3 has a CPU as a computing resource.

First, when looking at the task-resource mapping (task allocation) among the task scheduler's roles, the task scheduler maps Batched Task (BT) #1 to Batched Task (BT) #4 to VUR #1 to VUR #3. Task 1 and Task 5 may be performed in VUR #1, Task 2 and Task 3 may be performed in VUR #2, and Task 4 may be performed in VUR #3. To reflect this, task scheduling may be performed as shown in FIG. 4. This scheduling information is transmitted to the task-resource interface in the form of a “task allocation” table on the left side of FIG. 4.

Next, when looking at the data movement check among at the task scheduler's roles, data movement occurs when the movement of computation results to different computation resources is required based on the “task allocation” (see dotted arrows in FIG. 4). This data movement information is transmitted to the memory buffer manager in the form of a “data movement” table on the left side of FIG. 4.

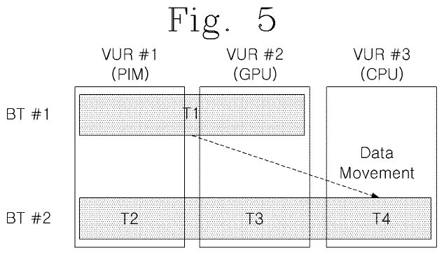

FIG. 5 illustrates the role of a memory buffer manager according to an embodiment of the present disclosure.

The memory buffer manager has two roles: i) managing memory information for each VUR and ii) managing input/output buffers for each VUR.

First, when looking at management of memory information for each VUR among the memory buffer manager's roles, the memory buffer manager maintains the remaining memory information for each VUR, determines whether VURs can be allocated to tasks, actually allocates memory, and stores weights in a suitable form in advance for tasks with the weights. In this case, the memory allocated for the input, output, weight, and parameter of a task is defined as a buffer.

Next, when looking at the management of input/output buffers for each VUR among the memory buffer manager's roles, each VUR has a buffer that stores an output value of finished computation or an input value of the next task, and a buffer that stores weights and parameters required for tasks. For a task allocated to multiple VURs, the memory buffer manager collects output values stored in respective buffers of the VURs. For example, in FIG. 5, Task T1 uses VUR #1 and VUR #2 simultaneously, and result values from the VURs (VUR #1 and VUR #2) are collected and stored so as to be used as an input value (Input) of T4 or exported as an output value (Output).

Referring back to FIG. 1, the task-resource interface plays the role of calling an actual Task-VUR computation implementation (Kernel), based on the batched task, input data, and VUR information received from the task scheduler.

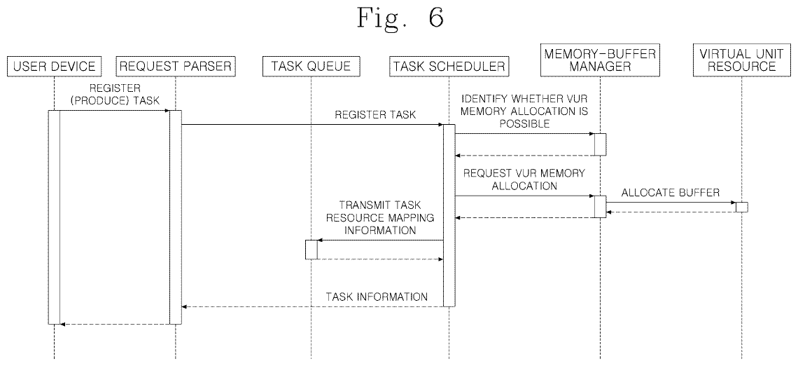

FIG. 6 illustrates a sequence diagram showing a task registration process according to an embodiment of the present disclosure.

The registration and deletion of a task are also treated as one of user requests, but unlike other requests, the registration and deletion of a task are processed directly by the task scheduler rather than the task queue. When the request parser receives a task registration (producing) request from a user terminal, the request parser transmits the request to the task scheduler. The task scheduler identifies the remaining VURs among VURs from the memory buffer manager (identifies whether VUR memory allocation is possible) and, if the allocation is possible, allocates information about a task to the VURs. In this case, the task scheduler transmits task-resource mapping information to the task queue, and the task queue references the transmitted information when making a batched task. After transmitting the task-resource mapping information to the task queue, the task scheduler also returns the information about the task to the request parser, and the request parser verifies the request by using the information about the task.

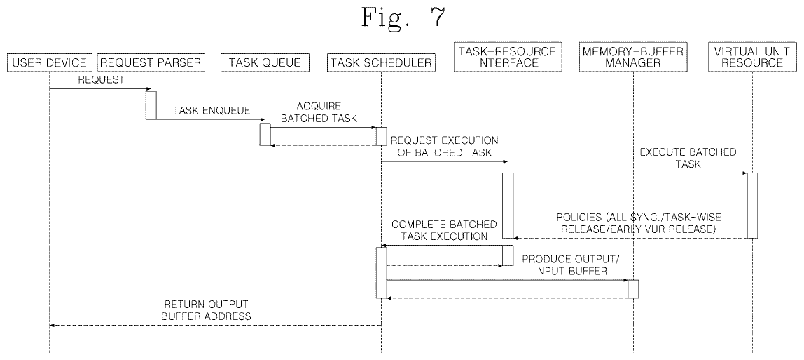

FIG. 7 illustrates a sequence diagram showing a task execution process according to an embodiment of the present disclosure.

The request parser parses a request received from a user terminal into task units, and transmits the parsed tasks to the task queue (task enqueue). The task queue groups the received tasks to define a batched task, and transmits the batched task to the task scheduler. The task queue manages the tasks corresponding to each request from the request parser, produces a batched task, and transmits the batched task to the task scheduler. When producing the batched task, at least one of methods 1 to (3) below may be used to prevent a task, which came in first, from being moved to a lower priority.

Priority Update: the priority of tasks in the task queue is incrementally increased each time a task is enqueued.

Dead Line: A task that exceeded a certain time period is always executed with the highest priority.

Windowed FIFO: Tasks are grouped into windows in order and processed using First In First Out (FIFO) on a per-window basis, wherein parallel execution of the tasks is considered within the windows.

Then, the task scheduler transmits a task (or a batched task), an input/output buffer, and task-resource mapping information to the task-resource interface and transmits a task (or batched task) execution request so that the task can be executed. When using heterogeneous VURs (wherein the term “heterogeneous” implies that computing resources or memory resources are different), the following policies may be included to consider a computation time difference, etc. These policies may be configured differently for each batched task (or for each task).

All Synchronize: Wait until all tasks executed on all VURs for the current batched task are completed.

Task-wise Release: VURs on which a task has been completed are allowed to be used immediately.

Early VUR Release: When computation is completed on a VUR, the VUR is immediately available for use.

When the execution of the batched task is completed, the task-resource interface transmits the completion information to the task scheduler. The task scheduler requests the memory buffer manager to produce a buffer for output information of the batched task. When information about the buffer for the output information of the batched task is received from the memory buffer manager, the task scheduler transmits the information to the user terminal.

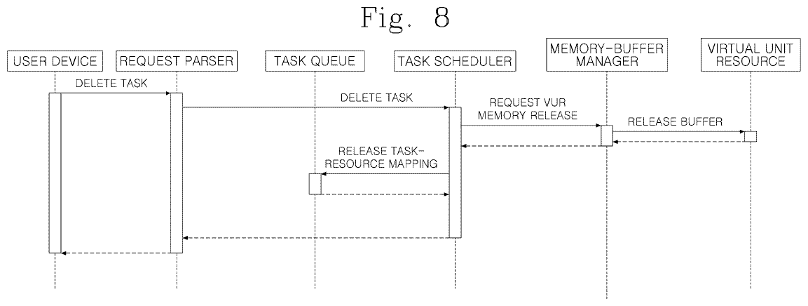

FIG. 8 illustrates a sequence diagram showing a task deletion process according to an embodiment of the present disclosure.

The task deletion process in FIG. 8 refers to the process of deleting and deallocating task-resource mapping information, buffer information, etc. associated with a task.

Task deletion is treated as one of user requests, but unlike other requests, the task deletion is processed directly by the task scheduler rather than the task queue. When the request parser receives a task deletion request from a user terminal, the request parser transmits the task deletion request to the task scheduler. The task scheduler transmits a VUR memory release request to the memory buffer manager, and the memory buffer manager, which has received the VUR memory release request, executes the deletion and deallocation of buffer information of a relevant VUR. In this case, the task scheduler transmits a task-resource mapping information release to the task queue, and the task queue executes the corresponding task-Resource mapping information release.

FIG. 9 illustrates PIM general matrix-vector multiplication (GEMV) computation process according to the prior art.

In the process of QKV multi-head attention computation, QK^{T} GEMV computation between vector Q and matrix K, which computes an attention score, and SV GEMV computation between vector S and matrix V, which computes an attention value, are important. However, the sizes of the matrices K and V differ according to LLM models. If these matrices are not properly arranged according to the unit of computation processed by PIM, the efficiency thereof will be reduced. Therefore, a technique for properly arranging these matrices is required.

The present disclosure presents a QKV multi-head attention computation acceleration technique that maximizes the efficiency of PIM GEMV computation. The rearrangement of input/output vectors and a weight matrix and the modification of GEMV computation are required to conform to a PIM computation process. Furthermore, for computational optimization, the method needs to be changed according to the shape of K and V matrices. Therefore, the present disclosure presents i) a K matrix rearrangement and GEMV computation technique for calculating an attention score, and ii) a V matrix rearrangement and GEMV computation technique for calculating an attention value.

Referring to FIG. 9, the conventional PIM GEMV computation is performed in specific size units. However, in the case of attention-score computation, the size of a matrix is too small horizontally compared to a PIM computation unit, so most of the space has to be filled with zeros, thereby making it difficult to fully expect performance improvement in the attention-score computation. In the case of attention-value computation, the horizontal size of a matrix is larger than a PIM computation unit, thereby requiring the PIM GEMV computation to be performed multiple times. Furthermore, the vertical size of the matrix is too small compared to the PIM computation unit, thereby resulting in most of the area under the PIM GEMV being unusable.

Referring to the left side of FIG. 9, in the conventional PIM, a GEMV computation I×W=0 is performed on a matrix W of fixed size M×N (M>>N). This GEMV computation \textcircled{1} performs a vector multiplication between Input and Weight, and then \textcircled{2} adds the multiplied vectors, thereby calculating an output.

However, when applying M×N unit computation to an LLM model, the following problems occur. (1) In the case of a m×n-sized K matrix in the attention-score computation, it is common that N>>n, and thus, even when an output is produced in parallel by performing vertical batching as shown in FIG. 9, most of the empty space on the right side remains unutilized. Furthermore, (2) in the case of a m′×n′-sized V matrix in the attention-value computation, it is common that M>>m′, and thus the lower space is underutilized. Additionally, it is also common that n′>N, and thus the GEMV computation often needs to be performed multiple times to calculate one output.

The present disclosure achieves performance improvement by rearranging input and output vectors and weight matrices used in the attention-score computation and the attention-value computation to conform to PIM, and by modifying the GEMV computation. The rearrangement allows additional data to be placed in the space that was previously filled with zeros, thereby increasing the number of effective computations processed within a unit GEMV computation. As a result, the total number of GEMV unit computations is reduced compared to existing techniques, resulting in performance improvement To this end, the present disclosure presents (A) a PIM-friendly attention core computation acceleration method and (B) a PIM-friendly attention-value computation acceleration method.

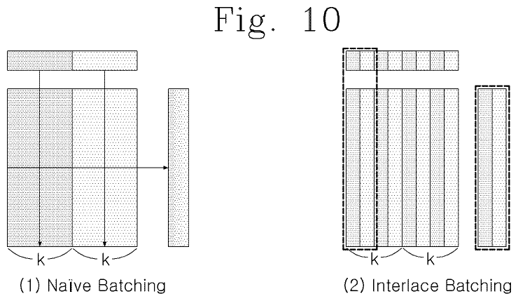

FIG. 10 illustrates a PIM-friendly attention-score computation acceleration method according to an embodiment of the present disclosure.

In a current PIM library, GEMV computation is performed using the aforementioned vector multiplication and addition. In particular, when performing vector addition, the vector addition is performed in units of a group of k column vectors corresponding to a transaction size of relevant hardware. Then, the results of performing vector addition in units of a group of k column vectors are combined using a vector addition computation on a GPU to form a single output vector (see (1) Naïve Batching on the left).

However, (1) Naïve Batching places different matrices for different GEMV computations side by side and combines computation result values of the two matrices into one to produce an output, and thus is inappropriate for actual computation (since the output is the sum of different matrices for different GEMV computations). To solve this problem, as in (2) Interlace Batching, when each matrix is divided and arranged into column vectors (column vectors, the number of which corresponds to a divisor of transaction size k, e.g., k/2 or k/4) within k unit column vectors, the positions of column vectors being added within a transaction are not changed, and thus, in the PIM GEMV output step, outputs between different matrices are not added together (i.e., in (2) Interlace Batching, in the case of the k/4 column vectors, computation is performed between only column vectors having the same pattern, and is not performed not between column vectors having different patterns). Then, when modification is made to reduce the number of additions so that each matrix output is not added in a GPU vector addition process, (i.e., in (2) Interlace Batching, in the case of k/4 column vectors, computation is performed between only column vectors having the same pattern, and is not performed between column vectors having different patterns), a batching GEMV computation may be successfully performed.

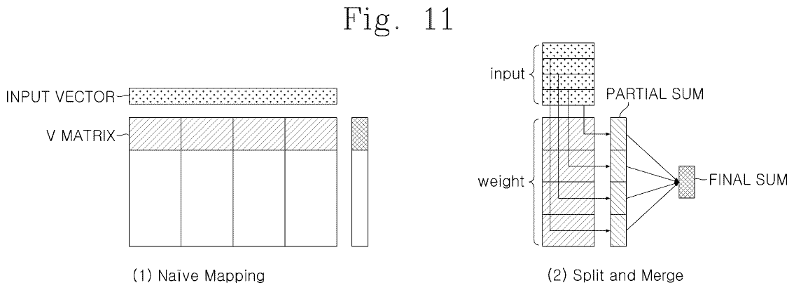

FIG. 11 illustrates a PIM-friendly attention-value computation acceleration method according to an embodiment of the present disclosure.

Because a V matrix is long horizontally, calculating the same requires multiple PIM GEMV unit computations to be executed by moving sideways. Therefore, as in (1) naïve mapping, most of the lower empty space must be filled with zeros to perform computation, thereby reducing the efficiency thereof. As in (2) Split and Merge, the matrix is sliced into column units and then extended downward to fit PIM GEMV units. An input vector is also sliced to match this size. When the sliced input and weight are batched using the PIM GEMV unit computation, partial sums are extended downward, as in (2) Split and Merge. These partial sums are added together using an additional GPU kernel to compute the final sum.

Device to which the Proposed Method of the Present Disclosure May be Applied

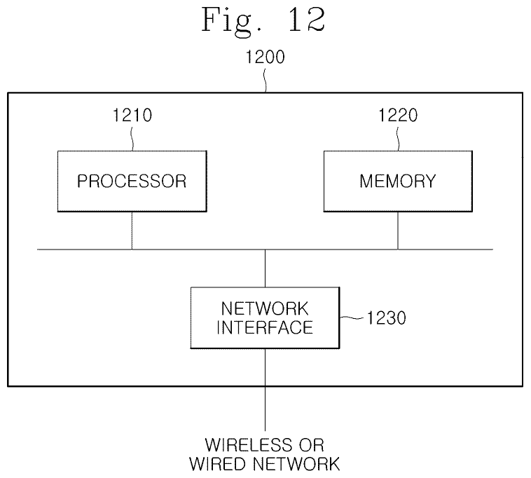

FIG. 12 illustrates a device 1200 to which the proposed method of the present disclosure may be applied. The device 1200 may be a server or a terminal for performing computation by using a CPU or GPU and PIM together.

Referring to FIG. 12, the device 1200 may be a server device or a terminal device configured to implement a process for a method for performing computation by using a CPU or GPU and PIM together.

For example, the device 1200 to which the proposed method of the present disclosure may be applied may include a network device such as a repeater, a hub, a bridge, a switch, a router, or a gateway, a computer device such as a desktop computer or a workstation, a mobile terminal such as a smartphone, a portable device such as a laptop computer, house electric appliances such as digital televisions, a movement means such as an automobile, and the like. In another example, the device 1200 to which the present disclosure may be applied may be included as part of an application specific integrated circuit (ASIC) implemented in the form of a system on chip (SoC).

A memory 1220 may be operatively connected to a processor 1210, may store programs and/or instructions for processing and control performed by the processor 1210, and may store data and information used in the present disclosure, control information required for processing the data and the information according to the present disclosure, temporary data generated during processing of the data and the information, and the like. The memory 1220 may be implemented as a storage device such as read-only memory (ROM), random-access memory (RAM), erasable programmable read-only memory (EPROM), electrically erasable programmable read-only memory (EEPROM), flash memory, static RAM (SRAM), a hard disk drive (HDD), a solid-state drive (SSD), or the like.

The processor 1210 may be operatively connected to the memory 1220 and a network interface 1230, and controls the operation of each module within the device 1200. In particular, the processor 1210 may perform various control functions for performing the proposed method of the present disclosure. The processor 1210 may also be referred to as a controller, a microcontroller, a microprocessor, a microcomputer, etc. The proposed method of the present disclosure may be implemented using hardware, firmware, software, or a combination thereof. When the present disclosure is implemented using hardware, the processor 1210 may include an application specific integrated circuit (AS IC), a digital signal processor (DSP), a digital signal processing device (DSPD), a programmable logic device (PLD), a field programmable gate array (FPGA), or the like configured to perform the present disclosure. Meanwhile, when the proposed method of the present disclosure is implemented using firmware or software, the firmware or the software may include instructions that are related to a module, a procedure, or a function for performing functions or operations necessary for implementing the proposed method of the present disclosure. The instructions may be stored in memory 1220 or on a computer-readable recording medium (not shown) separate from the memory 1220. The instructions may be configured to, when executed by processor 1210, cause the device 1200 to implement the proposed method of the present disclosure.

Furthermore, the device 1200 may include the network interface device 1230. The network interface device 1230 may be operatively connected to the processor 1210, and the processor 1210 may control the network interface device 1230 to transmit or receive wireless/wired signals carrying information and/or data, signals, messages, etc. over a wireless/wired network. The network interface device 1230 supports various communication standards, such as IEEE 802 series, 3GPP LTE(-A), and 3GPP 5G, and may transmit and receive control information and/or data signals in accordance with the communication standards. The network interface device 1230 may also be implemented outside the device 1200 as needed.

The heterogeneous computing framework described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SIS D) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method for performing computation using processing-in-memory (PIM), the method comprising:
parsing a user request into multiple tasks;
grouping the multiple parsed tasks into at least one batched task unit;
scheduling execution of the batched task unit, based on data movement between the multiple tasks; and
executing the multiple tasks according to the scheduling.

2. The method of claim 1, wherein the multiple tasks are classified based on computation and a virtual unit resource (VUR).

3. The method of claim 2, wherein the VUR is defined as a pair of a computing resource and a memory resource.

4. The method of claim 3, wherein the computing resource comprises any one or any combination of any two or more of a CPU, a GPU, and PIM.

5. The method of claim 4, wherein the memory resource is allocable to the computing resource.

6. The method of claim 3, wherein the multiple tasks are registered in case that the memory resource of the VUR is allocable.

7. The method of claim 1, wherein multiple tasks grouped into a same batched task are performed simultaneously in parallel with each other.

8. The method of claim 1, wherein the batched task is defined by multiple tasks grouped into the batched task and whether data is moved to a next batched task.

9. The method of claim 1, wherein in the parsing of the user request into the multiple tasks, each task, which constitutes the multiple tasks, is parsed into different tasks in case that either one or both of computation and a VUR are different.

10. A non-transitory computer-readable storage medium storing instructions that, when executed by a processor, configure the processor to execute the method for performing computation using PIM in claim 1, in combination with hardware.

11. A device for performing computation using processing-in-memory (PIM), the device comprising a processor, wherein the processor is configured to:
parse a user request into multiple tasks;
group the multiple parsed tasks into at least one batched task unit;
schedule execution of the batched task unit, based on data movement between the multiple tasks; and
execute the multiple tasks according to the scheduling.

12. The device of claim 11, wherein the multiple tasks are classified based on computation and a VUR.

13. The device of claim 12, wherein the VUR is defined as a pair of a computing resource and a memory resource.

14. The device of claim 13, wherein the computing resource comprises any one or any combination of any two or more of a CPU, a GPU, and PIM.

15. The device of claim 14, wherein the memory resource is allocable to the computing resource.

16. The device of claim 13, wherein the tasks are registered in case that the memory resource of the VUR is allocable.

17. The device of claim 11, wherein multiple tasks grouped into a same batch task are performed simultaneously in parallel with each other.

18. The device of claim 11, wherein the batched task is defined by multiple tasks grouped into the batched task and whether data is moved to a next batched task.

19. The device of claim 11, wherein in the parsing of the user request into the multiple tasks, each task, which constitutes the multiple tasks, is parsed into different tasks in case that either one or both of computation and a VUR are different.
